(19) United States
(12) Patent Application Publication
(10) Pub. No.: US 2013/0290340 A1
(43) Pub. Date: Oct. 31, 2013

(54) Providing Control Over a Personalized Category of Information

(71) Applicants: Henri Jacques Suermondt, Sunnyvale, CA (US); Craig Peter Sayers, Menlo Park, CA (US); Rajan Lukose, Oakland, CA (US); Mark S. Kolich, Los Altos, CA (US); Ignacio Zendejas, Mountain View, CA (US)

(72) Inventors: Henri Jacques Suermondt, Sunnyvale, CA (US); Craig Peter Sayers, Menlo Park, CA (US); Rajan Lukose, Oakland, CA (US); Mark S. Kolich, Los Altos, CA (US); Ignacio Zendejas, Mountain View, CA (US)

(21) Appl. No.: 13/817,667

(22) PCT Filed: Oct. 27, 2010
(86) PCT No.: PCT/US10/54243

§ 371 Date: Feb. 19, 2013

(51) Int. Cl. G06F 17/30

(52) U.S. Cl. CPC G06F 17/30702
USPC 707/740

(57) ABSTRACT

Embodiments disclosed herein relate to providing control over a personalized category of information. In one embodiment, a personalized category of information is determined based on stored information associated with the use of an electronic device 110. In one embodiment, user feedback on the personalized category of information is received. If the user feedback comprises a rejection of the personalized category of information, the personalized category of information is discarded.

### BACKGROUND

Information related to the use of an electronic device may be used to determine categories or topics likely to be of interest to a user. The information about a user's interests may be used, for example, to select content to distribute to the user. Categories likely to be of interest to a user may be determined, for example, by monitoring a user's use of an electronic device in real-time, such as by monitoring website traffic.

### BRIEF DESCRIPTION OF THE DRAWINGS

In the accompanying drawings, like numerals refer to like components or blocks. The drawings show example implementations. The following detailed description references the drawings, wherein:

FIG. 1 is a block diagram illustrating one example of a computing system.

FIG. 2 is a flow chart illustrating one example of a method for providing control over a personalized category of information.

FIG. 3 is a block diagram illustrating one example of determining personalized categories of information.

FIG. 4 is a flow chart illustrating one example of a method for receiving feedback related to a personalized category of information.

FIG. 5 is a block diagram illustrating one example of receiving feedback related to personalized categories of information.

### DETAILED DESCRIPTION

Individuals may be overwhelmed with the large amount of available information. For example, websites may contain information about news, sports, television shows, movies, magazines, websites, and concerts. An individual may take a large amount of time filtering to locate information that is of interest to the individual. A personalized profile may be created that includes categories of information likely to be of interest to a user. In some cases, a personalized profile is created with information entered by a user. For example, a user may enter information about his likes or dislikes. However, manually entering information about a user's interests may be a cumbersome process. A personalized profile may be created by monitoring a user's use of an electronic device in reel-time. For example, software may be installed on an electronic device that monitors activity on the electronic device, such as website traffic and use of programs installed on the electronic device. However, such software may present concerns, such as concerns related to the type of information tracked, the amount of information tracked, or the continual nature of the tracking process. In some cases, a computer user may have concerns about secondary uses of behavioral information related to the user's use of the computer. In addition, the software may prevent a user from ensuring the accuracy of conclusions obtained based on the analyzed information.

In one implementation, stored information on an electronic device is analyzed to determine a user's interests. For example, stored content on an electronic device, such as website history, music files, and electronic books, may be analyzed, and a personalized category of information likely to be of interest to the user may be determined based on the stored content. In some implementations, a personalized profile may be created to include a list of personalized categories of information associated with a user. In addition, using stored content, such as during a specific session, may provide transparency and decrease concerns associated with analyzing user data because the stored content may be analyzed at a particular point in time. In some cases, a user may further control the process by limiting the type of stored content analyzed, such as limiting analysis to stored music files.

In one implementation, user feedback on a determined personalized category of information is used to provide a user further control over the determination and use of a personalized category of information. The user feedback may, for example, indicate that a user rejects a determined personalized category of information, such as because the user finds it private, embarrassing, or inaccurately reflecting his interests. A rejected personalized category of information may be discarded. For example, a personalized category of information may be deleted and not used or transferred if it is rejected. The related stored information to determine the personalized category may also be discarded. For example, the underlying stored information used to determine the rejected personalized category may be discarded such that it is not used to determine other personalized categories. Discarding the personalized category and the related stored information may assure a user that information capable of revealing private details are not used or distributed. In addition, further analysis may be more accurate and acceptable to the user if it is not based on the underlying information that was used to determine the rejected personalized category of information.

In one implementation, a user may accept a personalized category. In some implementations, accepting a personalized category allows it to be used. For example, an accepted personalized category may be transmitted to a third party or used to create a personal profile for selecting or filtering content for the user. For example, an online magazine or personalized newsfeed may be created by identifying content related to an accepted personalized category of information.

In one implementation, a user may provide feedback to modify a personalized category of information. For example, a personalized category may indicate that a user is interested in sports and particularly golf, but a user may modify it to show that he is interested in sports and particularly baseball. In one implementation, the modified category may then be used, such as by selecting content or by sending the personalized category to a third party. In some cases, a personalized category may be modified to indicate acceptable uses. For example, a personalized category may be presented to a user, and a user may modify it to indicate that use of the personalized category should be limited to selecting sports content from a particular third party.

Allowing for feedback related to a personalized category of information may provide greater control and accuracy in determining a user's interests. For example, a user may maintain control over whether and how a personalized category of information may be used. As a result of providing user control, a user may be more comfortable allowing an automated system to analyze the user's stored content on an electronic device.

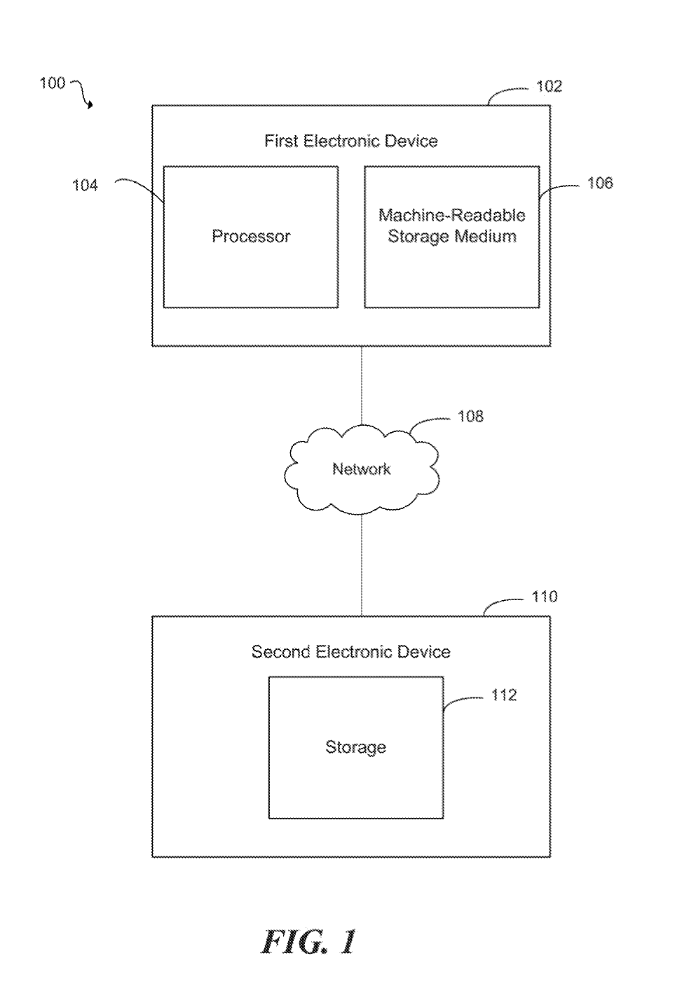

FIG. 1 is a block diagram illustrating one example of a computing system 100. The computing system may include, for example, a first electronic device 102, a second electronic device 110, and a network 108. The first electronic device 102 and the second electronic device 110 may be any suitable electronic devices. For example, the first electronic device 102 and the second electronic device 110 may be a personal computer, server, or mobile phone. The first electronic device 102 and the second electronic device 110 may communicate via the network 108. The network 108 may be any suitable network, such as the Internet. In one embodiment, the second electronic device 110 is associated with a user, and the first electronic device 102 analyzes information related to the use of the second electronic device 110. In one example, multiple electronic devices associated with a user are analyzed by the first electronic device 102. In one implementation, the second electronic device 110 is a server with storage space allocated to multiple users, and the first electronic device 102 analyzes content stored on the second electronic device 110 associated with a particular user or group of users.

The second electronic device 110 may include the storage 112. The storage 112 may be any suitable storage, such as a volatile or non-volatile storage. The storage 112 may store information related to use of the second electronic device 110. For example, the storage 112 may store website traffic history or information about software installed on the second electronic device 110. The storage 112 may include stored media, such as music or video files. In one example, the second electronic device 110 includes multiple storages containing information related to the use of the second electronic device 110. The second electronic device 110 may include a processor for collecting data from the storage 112 and transmitting the data to the first electronic device 102, such as via the network 108.

The first electronic device 102 may include the processor 104 and the machine-readable storage medium 106. The processor 104 may be any suitable processor. For example, the processor 104 may be one or more central processing units (CPUs), semiconductor-based microprocessors, and/or other devices suitable for retrieval and execution of instructions stored in machine-readable storage medium 106. The processor 104 may fetch, decode, and execute instructions stored in the machine-readable storage medium 106 to implement the functionality described in detail below. As an alternative or in addition to fetching, decoding, and executing instructions, the processor 104 may include one or more integrated circuits (ICs) or other electronic circuits that comprise a plurality of electronic components for performing the functionality described below. In one implementation, the first electronic device 102 includes multiple processors. In some cases, a processor associated with one electronic device may perform some steps and a processor associated with another electronic device may perform other steps associated with the functionality described below. For example, a first processor may determine a personalized category of information, and a second processor may analyze feedback related to the determined personalized category of information.

The machine-readable storage medium 106 may be any electronic, magnetic, optical, or other physical storage device that stores executable instructions or other data (e.g., a hard disk drive, random access memory, flash memory, etc.). The machine-readable storage medium 106 may include instructions executable by the processor 104, for example, instructions to access from the second electronic device 110 stored information associated with the use of the second electronic device 110 and instructions to determine a personalized category of information based on the stored information associated with the use of the second electronic device 110. The machine-readable storage medium 106 may further include instructions to receive user feedback related to the personalized category of information. The machine-readable storage medium 106 may include instructions to determine whether the feedback indicates a rejection of the personalized category, and if the feedback indicates a rejection of the personalized category of information, instructions to discard the personalized category of information, where discarding the personalized category of information comprises making the personalized category of information unavailable for processing and instructions to discard the stored information related to determining the personalized category.

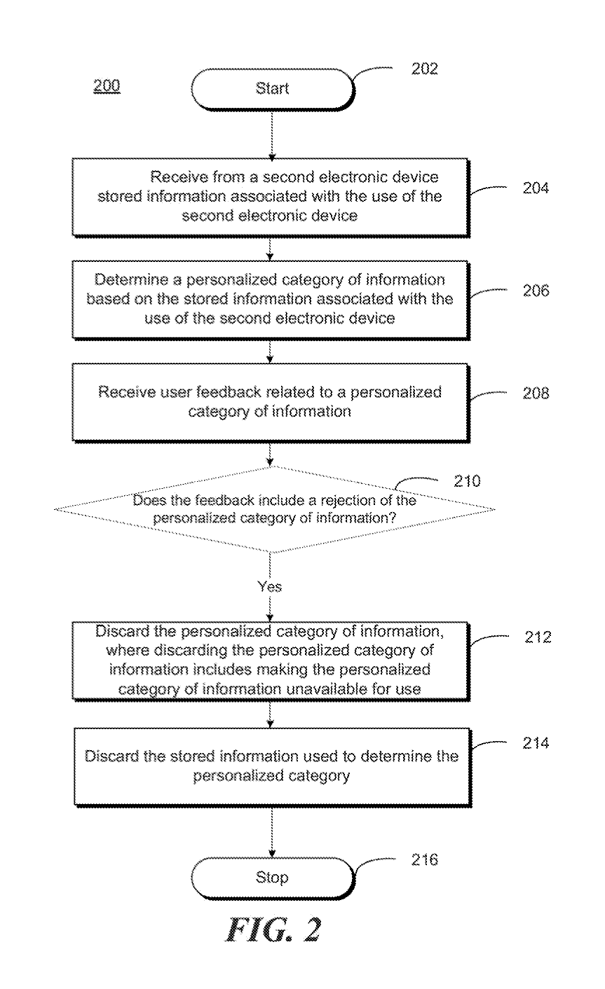

FIG. 2 is a flow chart illustrating one example of a method 200 determining a personal category of information. Stored information on electronic device may be analyzed to determine a personalized category of information likely to be of interest to a user, or in some cases a plurality of users, of the electronic device. Feedback may be received on the personalized category of information. For example, if the feedback indicates that the personalized category is rejected, such as because it is embarrassing or inaccurate, the personalized category may be discarded. The stored information used to determine the personalized category may also be discarded, for example, because the rejection of the personalized category may be a reflection as to whether the underlying related stored information is embarrassing or inaccurate.

Beginning at block 202 and moving to block 204, the processor 104, such as by executing instructions stored in the machine-readable storage medium 106, receives from the second electronic device 110 stored information associated with the use of the second electronic device 110. The stored information may be stored in the storage 112 or another storage associated with the second electronic device 110. In some cases, the processor 104 may receive information about stored content on multiple electronic devices associated with a user. For example, the processor 104 may receive information about stored content on a personal computer and stored content on a mobile phone. The stored information may be stored information associated with an account, such as emails saved in an inbox. In some cases, the stored information may be associated with multiple users, such as a computer used by several members of a family.

The stored information may be any suitable stored information related to the use of the second electronic device 110. For example, the stored information may include image files, media files, such as music or video, word processing documents, electronic presentations, electronic books, stored software programs, or information produced by the use of a software program, such as a computer-aided drawing. The stored information may include website history information, such as previously accessed Uniform Resource Locators (URLs). The stored information may include compiled information, such as song playlists. In some cases, the stored information may include information about features of stored information, such as the time that the information was accessed, the number of times the information was accessed. The features information may include, for example, information about strings of character sequences, phrases, words, word counts, or image key points, found in the stored information. The second electronic device 110 may determine the features information and send the features information to the first electronic device 102, such as in addition to or in place of sending the actual stored information. In one implementation, the first electronic device 102 receives stored information, and the first electronic device 102 determines information about the features of the stored content, such as character sequences in a word processing document.

The processor 104 may access the stored information in any suitable manner. For example, the second electronic device 110 may collect information stored in the storage 112 and send it to the first electronic device 102 via the network 108. In one embodiment, the processor 104 requests information from the second electronic device 110. The processor 104 may store information related to the use of the second electronic device 110 and retrieve it later. In one embodiment, information related to the use of the second electronic device 110 is stored in a database by the second electronic device 110, the first electronic device 102, or another electronic device, and the processor 104 retrieves the information from the database.

In one embodiment, a user is provided control over the type of information to be collected or analyzed. For example, a user may enter information into a user interface indicating what type of information is to be collected. The second electronic device 110 may receive information about the type of information to retrieve. The second electronic device 110 may retrieve the requested type of information from the storage 112 and transmit it to the first electronic device 102. In one implementation, the first electronic device 102 receives information about a type of stored information and retrieves that type of stored information from the second electronic device 110. For example, a user may indicate that information about electronic books stored on the second electronic device 110 may be collected, but information related to music files may not be collected. There may be a default setting indicating what type of information may be collected. In some implementations, multiple types of information are collected, but a user may indicate that not all of the collected information should be analyzed for determining the personalized category of information. For example, information about electronic books may be received by the processor 104, but there may be a setting to tell the processor 104 to disregard the information when determining the personalized category of information.

In one embodiment, the processor 104 periodically examines stored content on the second electronic device 110. In some implementations, a user has control over the timing of collecting stored data and what type of stored data is collected. For example, a user may indicate that stored data should be analyzed at the user's request or at a particular time period, such as once a month. In one embodiment, a user may indicate that live monitoring is preferred, and the processor 104 may switch to real-time monitoring of activity on the second electronic device 110 instead of analyzing stored content. For example, a user may determine that the stored content does not accurately represent his interests or that he would like the categories to be kept up to date with his changing interests. The processor 104 may receive real-time monitoring information and determine additional personalized categories based on the real-time monitoring information.

Continuing to block 206, the processor 104, such as by executing instructions stored in the machine-readable storage medium 106, determines a personalized category of information based on the stored information associated with the use of the second electronic device 110. The processor 104 may determine a personalized category likely to be of interest to a user of the stored information, such as a user of the second electronic device 110. The personalized category of information may be any suitable category, such as sports, news, or movies. In some cases the category may be hierarchical. For example, a sports category may include subcategories for basketball, baseball, and football. A category or subcategory may have any suitable level of detail, such as sports\basketball or sports\basketball\Michael Jordan. The personalized category for a user may include a high level category, such as sports, subcategories, such as basketball, or both high and low level categories. In some implementations, the processor 104 receives information, such as from a storage device, about a defined group of categories. In some implementations, the processor 104 creates new categories based on keywords in the stored information it receives.

In one implementation, determining a personalized category includes determining a degree associated with the category, such as a qualitative or quantitative degree, such as an interest level 1, 2, or 3 or an interest level of low, medium, or high. For example, a personalized category of baseball may be associated with an interest level of 3, and a personalized category of action movies may be associated with an interest level of 2. In some implementations, a degree of association is determined for categories, and categories with a degree of association above a particular threshold are presented to a user. For example, a category with a level of interest above a threshold of medium interest level may be determined to be a personalized category for the user and may be presented to the user.

In some cases, a profile including multiple determined personalized categories is created. The profile may include a list of determined personalized categories. In some cases, a profile may include information about relationships between the personalized categories in the profile. For example, the profile may be a tree, graph, or hierarchy.

The processor 104 may evaluate any portion of the stored information or any information related to the stored information in order to determine a personalized category of information. For example, the processor 104 may receive a website address from the second electronic device 110. The processor 104 may access the website and analyze the text on the website or analyze a title of a website address. The processor 104 may analyze titles of songs or movies or may access information about the words of a song or a movie transcript. The processor 104 may analyze additional information related to the stored content. For example, the processor 104 may receive information about the title of a song stored on the second electronic device 110 and retrieve information related to the song, such as the singer and year of release.

In some implementations, the processor 104 may use information in addition to stored information on the second electronic device 110 to determine a personalized category of information. For example, the processor 104 may receive account information about a user's blog or social networking account. The processor 104 may then access these accounts and analyze stored information from them in addition to information stored on the second electronic device 110.

The processor 104 may determine a personalized category of information in any suitable manner. For example, the processor 104 may select categories based on keywords associated with the stored content, such as keywords in titles, websites, and outside information describing the stored content. Categories may be based on frequently occurring keywords.

In one example, the processor 104 determines multiple personalized categories. In one implementation, the processor 104 determines that some of the determined personalized categories are of more interest than others. For example, the processor 104 may determine that a user is likely to be interested in sports and electronics, but is likely to be more interested in electronics than in sports. The processor 104 may select a subset of the determined categories, such as based on relevance or a determined interest level.

In some implementations, the processor 104 analyzes the stored content in relation to its context. For example, the processor 104 may create or retrieve a tree of categories representing a hierarchy of potential categories. In one embodiment, the categories also include concepts, such as a person or idea. A path in the tree may represent a hierarchy of categories where lower level tree categories are subcategories of, or concepts related to, categories higher on the tree path. For example, a path may be politics/United States politics/United States president, sports/golf/golf tournament winners, or golf tournament winners/charity work. The path may be useful for preserving the context of interest in a category, such as whether a person is interested in the golf game or charity work of golf tournament winners. The processor 104 may select a higher level category and which subcategories appear to be more interesting to a user. For example, a user may be highly interested in sports, but more interested in basketball than baseball. The personalized category may then be sports/basketball or basketball.

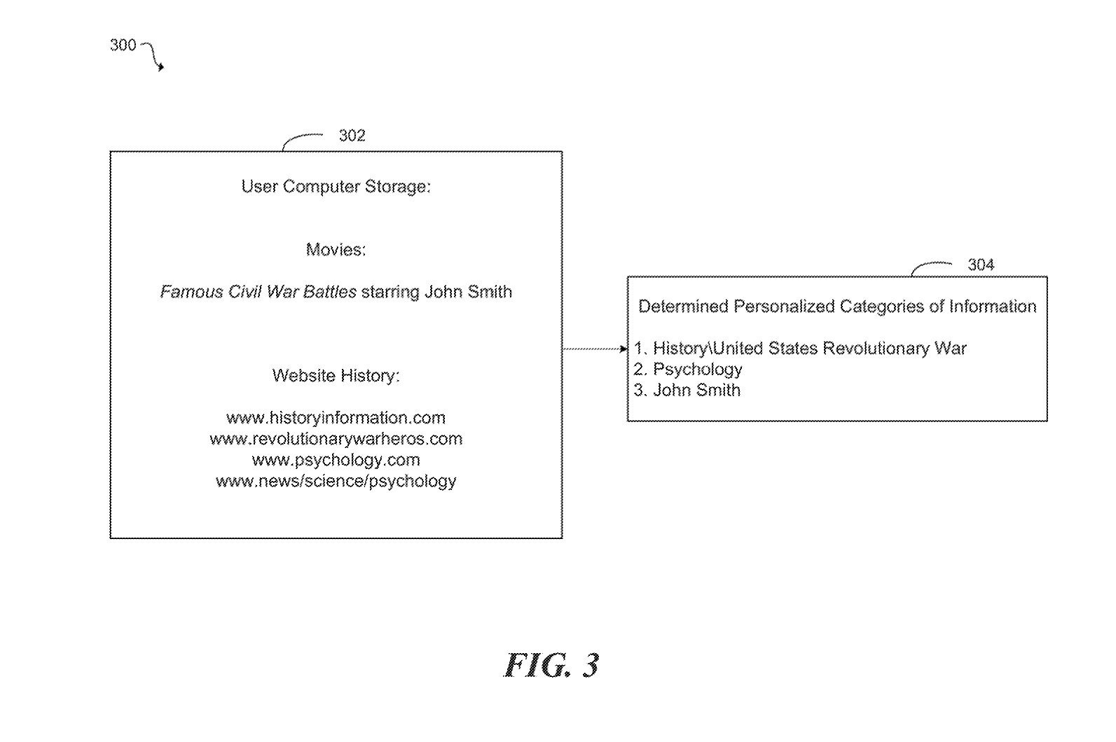

FIG. 3 is a block diagram illustrating one example 300 of determining personalized categories of information, such as by performing step 206 of the method 200 in FIG. 2. For example, block 302 shows information stored on a user's computer, including a movie and a list of several websites previously visited. Block 304 shows a list of three personalized categories of information based on the stored information. For example, the personalized categories include history\United States Revolutionary War, psychology, and John Smith. The three categories are related to the stored content.

Referring back to FIG. 2, proceeding to block 208, the processor 104, such as by executing instructions stored in the machine-readable storage medium 106, receives user feedback related to the determined personalized category of information. The feedback may provide a user control over which information is used or how it is used, such as whether a personalized category is stored, transmitted, or analyzed. The feedback may be any suitable response to the personalized category of information. For example, the feedback may indicate that a user agrees or disagrees with the personalized category determined by the processor 104.

The processor 104 may receive the feedback in any suitable manner. For example, the processor 104 may display on a display associated with the first electronic device 102 a user interface for displaying a visualization of the personalized category and receiving feedback. The user interface may display a single personalized category or multiple personalized categories. In some cases, the user interface displays multiple personalized categories and the relationships between them, such as a tree structure of determined personalized categories. The processor 104 may send the personalized category via a network to another electronic device to display it to the user. The user may input feedback information into a user interface displayed on the second electronic device 110 or another electronic device. The user interface may include feedback options, such as a selection option for rejecting and a selection option for accepting. The processor 104 may receive the feedback from another electronic device via the network 108. In one embodiment, the processor 104 retrieves the feedback from a storage. In some implementations, the feedback may be provided for a group of personalized categories. For example, multiple personalized categories may be rejected by using the same input button.

In one implementation, multiple personalized categories are presented to a user. The user may provide feedback on each of the personalized categories, on the set of personalized categories as a whole, or on a subset of the personalized categories. In one implementation, the determined personalized category is a hierarchical category, and the feedback may be related to a portion of the hierarchy. For example, the category may be sports/baseball, and feedback may be provided for sports/baseball or the baseball portion of the category.

Continuing to decision block 210, the processor 104, such as by executing instructions stored in the machine-readable storage medium 106, determines whether the feedback includes a rejection of the personalized category of information. The processor 104 may determine whether the feedback includes a rejection in any suitable manner. In one implementation, the processor 104 receives information that the user selected a rejection option on a user interface. In some cases, a user interface may present an option to accept a personalized category, and a failure to accept a personalized category is interpreted as a rejection of a category. In one implementation, a user may reject a portion of a hierarchical category. For example, a category may be sports/golf and the user may reject the golf portion.

A user may reject a personalized category for any reason. For example, a user may think that a personalized category does not reflect his interests. For example, a user r may have accidentally visited a website, downloaded music that he later decided he did not like, or used a software program for a purpose that is no longer relevant. In some cases, a user may think that although interested in the personalized category, it could be interpreted to infer personal information about him, such as religious affiliation, ethnic background, or gender. In some cases, a user may find the personalized category to be embarrassing or may find content likely to be selected based on the category to be embarrassing.

Moving to block 212, if the processor 104 determines that the feedback indicates that the personalized category is rejected, the processor 104, such as by executing instructions stored in the machine-readable storage medium 106, discards the personalized category of information, where discarding the personalized category of information includes making the personalized category of information unavailable for use. For example, the processor 104 may delete the personalized category of information from the first electronic device 102 or mark the personalized category of information to be deleted from the first electronic device 102. Discarding the personalized category may make it unavailable for use. For example, the personalized category of information may be discarded such that it is not processed to select content and is not shared to a third party. For example, the processor 104 may refrain from sending the personalized category to a remote storage or to a third party electronic device. A personalized profile including personalized categories of information may be used to select content for a user, and rejected categories may be removed from the personalized profile such that they are not used to select or filter content.

In one implementation, if the feedback includes an indication to reject the personalized category of information, the processor 104 sends communication indicating that the stored information used to determine the personalized category is discarded. For example, the processor 104 may send a communication to be displayed on the second electronic device 110 or another electronic device. The communication may assure the user that the rejected category is not be used by the electronic device 110 or by another electronic device. For example, a communication may list personalized categories that were deleted, or may display an updated list of personalized categories that does not include rejected personalized categories.

Proceeding to block 214, the processor 104, such as by executing instructions stored in the machine-readable storage medium 106, discards the stored information used to determine the personalized category. For example, if music files A, B, and C were used to determine a personalized category of jazz music that is rejected, the processor 104 discards music files A, B, and C from the first electronic device 102 such that they are not used for further processing and information about them is not transferred to a third party for use. The underlying information may be discarded from the first electronic device 102 such that it is not used to determine other personalized categories of information. In some cases, information about the stored information used to determine a rejected personalized category is used to derive other information. Discarding the personalized category from the first electronic device 102 may include discarding the derived information, such as additional determined personalized categories. In some implementations, the processor 104 discards the underlying information from the first electronic device 102 regardless of the feedback related to the determined personalized category. For example, the processor 104 may discard the underlying information if the feedback indicates that a personalized category is accepted or rejected. The method 200 then continues to block 216 to end.

In one implementation, the processor 104 determines, such as if the feedback does not indicate a rejection, whether the feedback includes an indication to accept the personalized category of information. An indication to accept a category may be received in any suitable manner. A user interface may present a user with an option to accept in any suitable manner. For example, the user may select an option on a user interface to accept a personalized category. In one implementation, failing to reject a category is interpreted as an acceptance of a personalized category. For example, a user interface may include a next button or other input that may be used to indicate proceeding with the personalized category without rejection. In some cases, if a user exits or the user interface remains idle without rejecting the personalized category, the personalized category may be determined to be accepted.

If the feedback indicates an acceptance of the determined personalized category, the processor 104 may allow use of the personalized category of information. For example, the processor 104 may use the personalized category of information or allow another electronic device, such as an electronic device associated with a third party, to use the personalized category of information. The processor 104 may transmit the personalized category of information to a third electronic device or may provide access to the personalized category of information, such as by storing the personalized category in a remote storage accessible by other electronic devices via a network. For example, another electronic device may retrieve a profile of personalized categories associated with a user from the remote storage to use the profile, such as to display the profile or select information based on the profile. In one implementation, the processor 104 selects information for the user based on the personalized category of information or filters information for the user based on the personalized category of information. The processor 104 may store the determined personalized category of information in a storage for later use or mark the determined personalized category indicating that it may be used.

In one implementation, a user may select from multiple types of acceptance. A user may accept a category indicating that it accurately reflects his interests, but may set some limits on how the information may be used or shared. For example, a user may accept a sports category and indicate that the category may be used or shared for the purpose of determining sporting events likely to be of interest to a user, but may not be used to determine movies likely to be of interest to a user. A user may indicate which parties may or may not have access to an accepted category. For example, a user may accept a sports category and indicate that it may be shared with sports.com, but not with news.com.

If the processor 104 determines that a category is accepted, the processor 104 or another electronic device may identify information likely to be of interest to the user or a group of users of the second electronic device 110 based on an accepted personalized category of information. For example, the processor 104 may retrieve the personalized category of information and use it to identify information likely to be of interest to the user of the second electronic device 110. The chosen information may be related to content, such as a television show, movie, or webpage. For example, if a user has a personalized category to a singer and the singer will be on a television talk show, the processor 104 may select this information. In some implementations, the selected information is related to non-electronic items, such as live performances, tourist locations, or printed items. The processor 104 may select information for a personalized communication, such as an electronic magazine or newsletter. For example, an electronic magazine may display articles or links to articles that are likely to be interesting to the user based on the categories associated with the user. The processor 104 may filter available information to tailor if for the user using the personalized category.

In some implementations, the processor 104 may format information for a personalized communication, such as by selecting the order in which items appear, based on the personalized category. In one embodiment, the processor 104 may select information to be displayed on the main screen of a news website to a particular user based on a personalized category. For example, an article about a topic likely to be of interest to the user may be displayed prominently, and links may be displayed for articles that are likely to be of less interest to the user.

In one example, the processor 104 transmits information indicating the chosen information. For example, the processor 104 may send an email, text message, or other communication indicating information about an upcoming television show, live performance, or book signing related to a personalized category. The processor 104 may send a communication to a user with a link to a webpage displaying selected content. The processor 104 may send an email or other communication displaying an article or other information selected by the processor 104. In one implementation, the processor 104 determines whether the user feedback indicates that the determined category of information should be modified. In one implementation, the processor 104 updates the personalized category based on the feedback and uses the modified personalized category, such as by selecting content based on the personalized category or by sharing the personalized category with a third party. In some cases, a user may decide that a determined personalized category of information is close to reflecting his interests but needs some modification. For example, a determined personalized category may be baseball, and it may be modified to be basketball. In some cases, a portion of a hierarchical personalized category may be modified. For example, a category sports\golf may be updated to sports\soccer. A category may be modified to be more specific, such as updated from sports to sports\hockey, or may be modified to be less specific, such as updated from sports\hockey to sports.

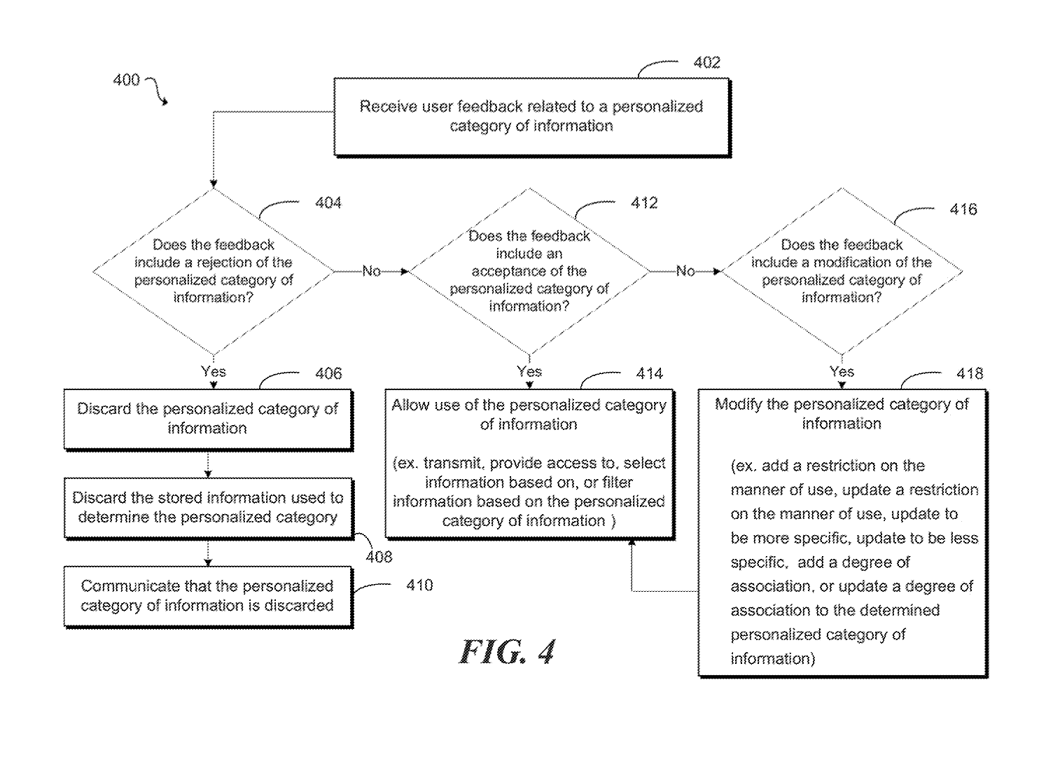

In one implementation, a user may modify a personalized category by adding or updating a restriction on the manner of use, such as shown in FIG. 4. For example, a personalized category of cooking\baking may be presented to a user, and a user may modify the category to indicate that the use of the personalized category cooking\baking should be limited to sending the category to or receiving information from cooking company A that hosts a particular cooking website. In some cases, a user may accept a personalized category and then add a restriction on the manner of use. In one implementation, a personalized category of information may be presented to a user with a particular user, and a user may update it. For example, a personalized category of sports\bowling may be presented to a user with a list of websites related to the personalized category that had been found in the stored content, and the user may add additional websites or remove websites from the list.

In some cases, underlying stored information may be related to multiple categories that are associated with different types of feedback. For example, an electronic device may include the book Pride and Prejudice by Jane Austen and the movie Sense and Sensibility adapted from a Jane Austen book. The category Jane Austen may be determined based on the book and movie, and the category romantic movie may be determined based on the movie. A user may reject the Jane Austen category and accept the romantic movie category. Different types of feedback related to the same underlying stored information may be handled in any suitable manner. For example, underlying information may be discarded if it relates to a rejected category even if the underlying information also relates to a category with another type of feedback. The book Pride and Prejudice and the movie Sense and Sensibility may be discarded even though Sense and Sensibility was used to determine an accepted category. In one implementation, the accepted category romantic movie may also be discarded because it was based on, rejected underlying information. In one implementation, if an accepted category is based on a piece of stored information, the stored information is not discarded even if the stored information was also used to determine a rejected category. For example, Pride and Prejudice may be discarded because it was related to a rejected category, but Sense and Sensibility may not be discarded because it was related to both an accepted and rejected category.

In one implementation, modifying a personalized category may include updating a degree of association with the personalized category. For example, a personalized category of books\18^{th} century literature may be selected with a degree of association of 9 out of 10 where 1 indicates little interest in a personalized category and 10 indicates great interest in a personalized category. A user may update the degree of association to 5 out of 10 to indicate less interest in the personalized category. In some cases, the personalized category may be determined without a degree of association, and a user may modify the personalized category to add a degree of association.

Any combination of feedback options may be provided. For example, options may be provided to reject a personalized category, reject or accept a personalized category, or reject or modify a personalized category. Additional feedback options may also be presented. The use of user feedback may result in a user feeling reassured that he has control over determining a personalized category of information and allowing use of the determined personalized category of information.

FIG. 4 is a flow chart illustrating one example of a method 400 for receiving feedback related to a personalized category of information. For example, block 402 shows that user feedback related to a personalized category of information is received, such as by step 208 of the method 200 in FIG. 2. Moving to block 404, it is determined whether the feedback indicates that the category is rejected, such as by decision block 210 of the method 200 in FIG. 2. If so, continuing to block 406, the personalized category is discarded and continuing to block 408, the stored information used to determine the personalized category is discarded. Proceeding to block 410, a communication may be sent to the user to indicate that the personalized category of information was discarded.

If the personalized category is not rejected, proceeding to block 412, it is determined whether the personalized category is accepted. If so, moving to block 414, the personalized category is allowed to be used, such as by transmitting, providing access to, selecting information based on, or filtering information based on the personalized category of information.

If the personalized category is not accepted, continuing to block 416, it is determined whether the feedback indicates that the personalized category is modified. If so, moving to block 418, the personalized category is modified, such as by adding a restriction on the manner of use, updating a restriction on the manner of use, updating to be more specific, updating to be less specific, adding a degree of association with, or updating a degree of association with the determined personalized category of information. Moving to block 412, the modified personalized category is allowed to be used.

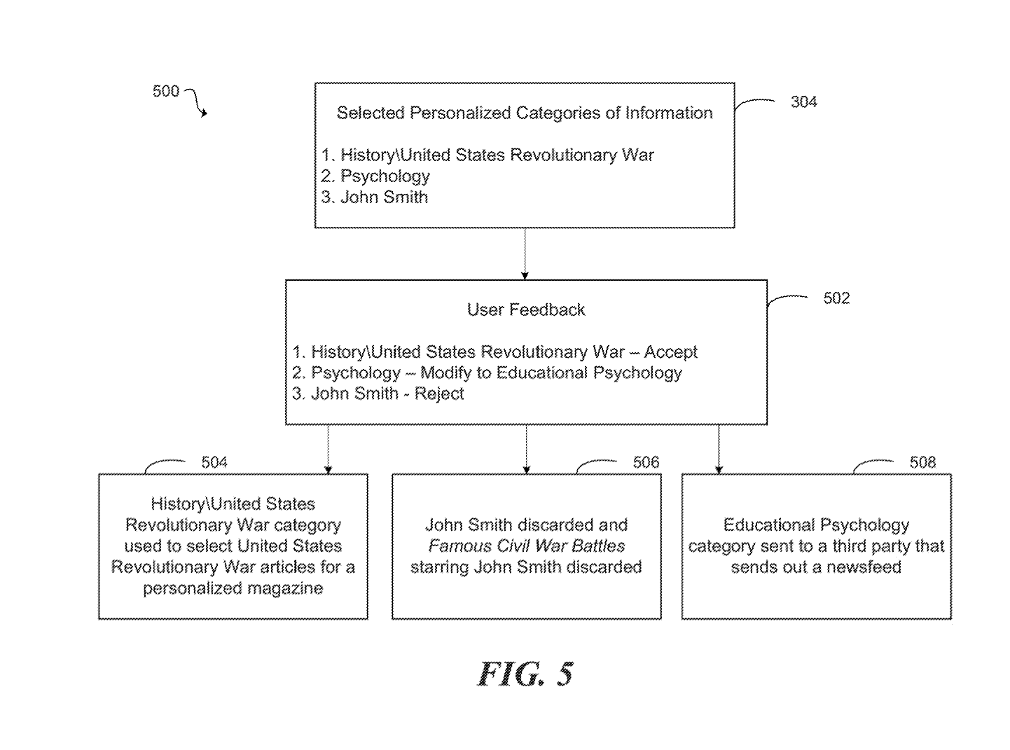

FIG. 5 is a block diagram illustrating one example 500 of receiving feedback related to personalized categories of information, such as using the method described in step 208 of the method 200 in FIG. 2. For example, block 304 shows the determined personalized categories from FIG. 3. Block 502 shows feedback for the determined personalized categories. For example, the History\United States Revolutionary War category is accepted, the psychology category is modified to educational psychology, and the John Smith category is rejected. Block 504 shows that the accepted History\United States Revolutionary War category is used to select articles for a personalized magazine. Block 506 shows that the John Smith category is discarded because it was rejected. Because the movie Famous Civil War Battles starring John Smith was used to determine the rejected category John Smith, information about the movie is also discarded. Block 508 shows that the modified category educational psychology is used by sending it to a third party for developing a personalized newsfeed.

Determining a personalized category of information based on stored information allows for a tailored category to be determined without monitoring the actions of a user in real-time. Using feedback related to the personalized category provides greater transparency and user control over the process. As a result, a user may feel reassured that his information is used in a manner that he dictates. In addition, the use of feedback may lead to personalized category more closely related to a user's interests.

1. A computing system for providing control over a personalized category of information, comprising:
a first electronic device 102 comprising a processor 104 to:
receive from a second electronic device 110 stored information associated with the use of the second electronic device 110;
determine a personalized category of information based on the stored information associated with the use of the second electronic device 110;
receive user feedback related to the personalized category of information; and
if the feedback comprises a rejection of the personalized category of information:
discard the personalized category of information, wherein discarding the personalized category of information comprises making the personalized category of information unavailable for use; and
discard the stored information used to determine the personalized category.

2. The computing system of claim 1, wherein if the feedback comprises a modification to the personalized category of information, the processor 104 modifies the personalized category of information based on the feedback.

3. The computing system of claim 1, wherein a modification to the personalized category of information comprises at least one of:
adding a restriction on the manner of use of the personalized category of information;
updating a restriction on the manner of use of the personalized category of information;
updating the personalized category of information to be more specific;
updating the personalized category of information to be less specific;
adding a degree of association to the personalized category of information; or
updating a degree of association to the personalized category of information.

4. The computing system of claim 1, wherein if the feedback comprises an acceptance of the personalized category of information, the processor 104 allows use of the personalized category of information.

5. The computing system of claim 4, wherein allowing use of the personalized category of information comprises at least one of:
transmitting the personalized category of information to a third electronic device;
providing access to the personalized category of information;
selecting information based on the personalized category of information; or
filtering information based on the personalized category of information.

6. A method for providing control over a personalized category of information, comprising:
receiving from a second electronic device stored information associated with the use of the second electronic device;
determining a personalized category of information based on the stored information associated with the use of the second electronic device;
receiving, by a processor associated with a first electronic device, user feedback related to the personalized category of information; and
if the feedback comprises a rejection of the personalized category of information:
discarding, by the processor, the personalized category of information, wherein discarding the personalized category of information comprises making the personalized category of information unavailable for use; and
discarding, by the processor, the stored information used to determine the personalized category.

7. The method of claim 6, wherein if the feedback comprises a modification of the personalized category of information, further comprising modifying the personalized category of information based on the feedback.

8. The method of claim 6, wherein a modification to the personalized category of information comprises at least one of:
adding a restriction on the manner of use of the personalized category of information;
updating a restriction on the manner of use of the personalized category of information;
updating the personalized category of information to be more specific;
updating the determined personalized category of information to be less specific;
adding a degree of association to the determined personalized category of information; or
updating a degree of association to the determined personalized category of information.

9. The method of claim 6, wherein if the feedback comprises an acceptance of the personalized category of information, further comprising allowing use of the personalized category of information.

10. The method of claim 9, wherein allowing use of the personalized category of information comprises at least one of:
transmitting the personalized category of information to a third electronic device;
providing access to the personalized category of information;
selecting information based on the personalized category of information; or
filtering information based on the personalized category of information.

11. A machine-readable storage medium encoded with instructions executable by a processor for providing control over a personalized category information, the machine-readable medium comprising instructions to:
access from a second electronic device stored information associated with the use of the second electronic device;
determine a personalized category of information based on the stored information associated with the use of the second electronic device;
receive user feedback related to the personalized category of information; and
if the feedback indicates a rejection of the personalized category of information:
discard the personalized category of information, wherein discarding the personalized category of information comprises making the personalized category of information unavailable for processing; and
discard the stored information related to determining the personalized category.

12. The machine-readable storage medium of claim 11, further comprising instructions to modify the personalized category of information if the feedback comprises an indication to modify of the personalized category of information.

13. The machine-readable storage medium of claim 11, further comprising instructions to use the personalized category of information if the feedback comprises an indication to accept of the personalized category of information.

14. The machine-readable storage medium of claim 11, wherein determining a personalized category of information comprises determining hierarchy of personalized categories.

15. The machine-readable storage medium of claim 11, wherein if the feedback comprises an indication to reject the personalized category of information, further comprising instructions to send a communication indicating that the stored information used to determine the personalized category is discarded.
